(19) United States
(12) Patent Application Publication
(10) Pub. No.: US 2014/0110274 A1
(43) Pub. Date: Apr. 24, 2014

(54) IONIC PAPER ELECTRONIC PLATFORM (IPEP)

(71) Applicants: Magnus Lestelius, Karlstad (SE); Elson Montibon, Karlstad (SE); Lars Järnström, Uppsala (SE)

(72) Inventors: Magnus Lestelius, Karlstad (SE); Elson Montibon, Karlstad (SE); Lars Järnström, Uppsala (SE)

(21) Appl. No.: 14/117,714

(22) PCT Filed: May 14, 2012
(86) PCT No.: PCT/SE2012/050511

§ 371 Date: Nov. 14, 2013

Related U.S. Application Data
(60) Provisional application No. 61/488,164, filed on May 20, 2011.

(30) Foreign Application Priority Data
Dec. 20, 2011 (SE) 1151228-2

(51) Int. Cl. G01N 27/26

(52) U.S. Cl. CPC G01N 27/26
USPC 205/793; 204/400; 204/406; 204/295; 204/415; 427/121

(57) ABSTRACT

A method of producing porous ionic conducting material, comprising the step of positioning an ionic substance into cellulosic material to form a continuous web or at least one individual sheet of porous ionic cellulosic based material, comprising the steps of first producing a web or sheet shaped cellulosic based substrate and thereafter applying liquid comprising room temperature ionic liquids. The porous ionic conducting material is used in flexible electronic device, by using the material as a substrate and applying a conducting material. A sensor assembly for sensing a property of an object, comprising at least one sensor wherein said sensor assembly comprises a flexible web or sheet shaped material. An authentication device for verifying the authenticity of an object. The device comprising at least one flexible electronic device. A method for verifying an authenticity of an object,

### FIELD OF THE INVENTION

The present invention relates to the area of porous ionic conducting materials, and more specifically to a method of producing porous ionic conducting material, comprising the step of positioning an ionic substance into cellulosic material to form a continuous web or at least one sheet of porous ionic cellulosic based material.

The invention furthermore describes a method for producing a flexible electronic device and a flexible web or sheet shaped material, a sensor assembly for sensing a property of an object, an authentication device for verifying the authenticity of an object and a method for verifying an authenticity of an object.

### BACKGROUND INFORMATION

There are flexible electronic devices on the market that utilize plastic as a substrate. Some attempts have been made to print conducting materials on the surface of a polyethylene coated paper, and deposit ionic compounds on the electronic architecture in order to achieve electrochemical functionalities of the conducting polymer. Porous solid electrolytes has attracted interest because of their potential applications in sensors, electrochemical transistors, high energy batteries, and generally in the large area electronics.

Since the discovery of conducting polymers in the late 1970s, research in the field of flexible electronics continues to flourish. Spin-coating, a layer-by-layer technique, printing, and rod coating are some of the methods that are being used to deposit conducting materials onto flexible substrates in order to create electronic structures on the surface. In most of the electronics structures, ionic materials are used to facilitate ion transfer as in electrochemical cells, photovoltaics, electrochemical transistors, and electrochromic devices. A number of ionic materials that are commonly employed but interest in the use of room-temperature ionic liquids (RTILs) has grown in recent years. Ionic liquids were first discovered in 1914 by Walden, but their huge potential in industry was realized only within the last decades. They are a class of compounds composed of organic cations and organic or inorganic anions. Their biodegradability, low volatility and low toxicity are some of the attractive properties useful in a sustainable process. The number of applications of RTILs is increasing in various fields including chemical reaction, electrochemical, separation applications, inorganic nanomaterials, and others. The ILs commonly used are those containing alkyl ammonium, alkylphosphonium, 1-alkylpyridinium, and 1,3-dialkylimidizalium cations. The chemical properties of ionic liquids are largely influenced by the nature of the anion. In recent years, research has focused on using ionic liquids in dissolving cellulose. A growing number of publications dealing with dissolution of cellulosic materials are appearing not only in the pulp and paper sector but also in other research fields.

In US 2010/0032661 is disclosed a transistor having a semiconductor layer and a gate electrode separated by a polymer membrane which is ion-conducting. The polymer membrane can be in the form of paper impregnated with ion-conducting liquid and printing technique can be used for forming the organic semiconductor layer. The ion-conductivity is achieved by sulfonating the fibers before producing the paper. However, this method may not give sufficiently high ionic conductivity, and modifying the fiber before paper formation means that it will be difficult to selectively position the portion of paper sheet that suppose to be conductive

A conductive material comprising a thin film and a paper based on natural cellulose-based fibers is disclosed in WO2009115913. Conductive components can be deposited e.g. by means of ink-jet printing.

In WO2009096802 it is described the use of paper material as a base when producing simple integrated electric and/or electronic circuits. The paper surface can be treated or untreated. However, the document does not disclose paper as an ion conductor.

Hence there is still a need to develop a ion conducting material that may partially or wholly be made of renewable material which is also biodegradable.

### SUMMARY OF THE INVENTION

It is an object of the present invention to overcome or at least minimize at least one of the drawbacks and disadvantages of the above described techniques. This can be obtained by a method as defined in claim 1.

Thanks to the invention an ion conductor is obtained which is partly or wholly made of renewable material and which may be biodegradable. It is possible to directly deposit the liquid comprising the ionic liquid or blend of ionic liquids to the part of the paper that needs to be conductive. It is also possible to tune in the desired conductivity level by modifying the blends of ionic liquids comprised in said liquid before depositing the blend into the fiber network. This implies that the deposition of ionic liquid may be maximized in the fiber network, and obtain the highest conductivity level possible. Paper is composed of porous fibers, and hence, the ionic liquid can creep into the pores. The ionic liquid/s binds readily with the cellulosic fibers.

The liquid is applied by means of a surface treatment method able to transfer the room temperature ionic liquids to the cellulosic material. Said application includes a step of applying pressure arranged to ensure the positioning of the ionic liquid into the cellulosic material, preferably in the form of said surface treatment method, which preferably is a printing technique or a coating technique able to transfer the room temperature ionic liquids to the cellulosic material.

A sizing layer may be applied onto at least one side of said web or sheet. In some embodiments both sides may be applied with a sizing layer. Said sizing layer having a thickness in the range of 1-120 μm, preferably in the range of 5-60 μm, and more preferred 20-40 μm.

The invention also concerns a method for producing a flexible electronic device based on the method of producing porous ionic conducting material, by using a substrate and applying a conducting material, which material is supplied to form at least one electronic device. Said electronic device comprises at least one electro chemical transistor.

The invention also concerns a flexible web or sheet shaped material comprising an ionic substance being mainly formed by a cellulosic fiber web or sheet comprising ionic substances applied by means of a liquid. Said web or sheet shaped material comprises at least 90% renewable material, preferably biodegradable renewable material while said ionic substance is mainly applied by deposition or application of said liquid comprising room temperature ionic liquids and that at least one of the sides of said web or sheet (1) is arranged with sizing layer.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1a shows a schematic view of a cellulosed based material,

FIG. 1b shows a schematic view of an ionic paper,

FIG. 2 shows a schematic view of a surface sized ionic paper,

FIG. 3 shows a schematic view of the surface-sized ionic paper printed with conducting material,

FIG. 4 shows a schematic view of the surface-sized ionic paper printed/coated with conducting material on both sides,

FIG. 5 shows a schematic side view of the surface-sized ionic paper printed/coated with conducting material on both sides and an applied voltage between the conducting materials,

FIG. 6a shows a side view of an electrochemical transistor that can be built on ionic paper,

FIG. 6b shows a top view of the electrochemical transistor shown in FIG. 5a that can be built on the ionic paper,

FIG. 7a shows a top view of an electrochromic device that can be built on ionic paper,

FIG. 7b shows a side view of the electrochromic device shown in FIG. 6a that can be built on ionic paper,

FIG. 8 shows ionic conductivity of ionic paper as a function of voltage,

FIG. 9 shows ionic conductivity of ionic paper as a function of relative humidity,

FIG. 10 shows ionic conductivity of surface-sized by using nano fibrillated cellulose (SIY-NFC) or starch-latex (SIY-SL) as surface-sizing agent, ionic papers as a function of relative humidity

FIG. 11 shows temperature dependence of ionic conductivity of paper containing [bmim]BF4,

FIG. 12 shows microscopic images (magnification: 20×) of surface-sized ionic paper (SIYSSG) (a) front, and (b) back after application of oil-based dye (Sudan Red) on the front,

FIG. 13 shows Nyquist plots of and the Randles equivalent circuit for unsized and surface-sized ionic papers,

FIG. 14 shows a schematic representation of possible electronic devices that can be constructed on top of an ionic paper surface

### DETAILED DESCRIPTION OF THE PREFERRED EMBODIMENTS

The following detailed description, and the examples contained therein, are provided for the purpose of describing and illustrating certain embodiments of the invention only and are not intended to limit the scope of the invention in any way.

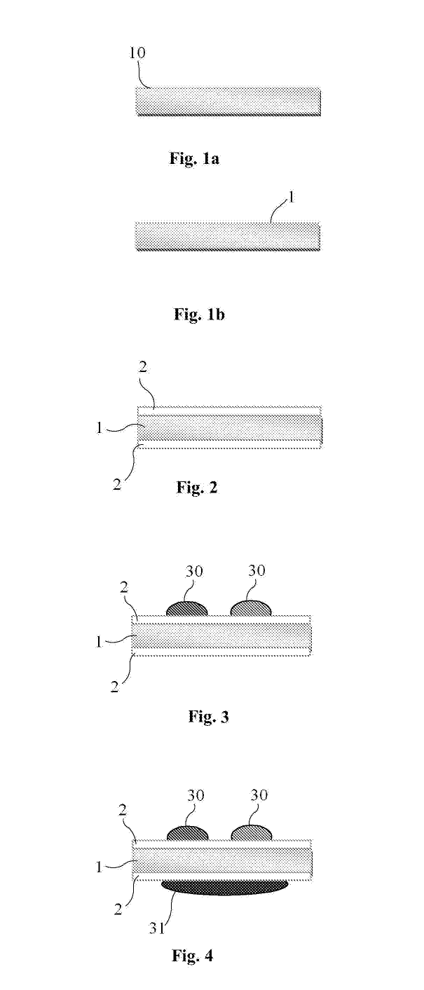

In FIG. 1a a cellulosic based material 10 is shown, having the form of a sheet of paper.

In FIG. 1b an ionic cellulosic based material 1, which in FIG. 1b is shown as an ionic sheet or paper 1, is schematically shown. The ionic paper 1 is preferably a robust and porous material that is useful as platform and or component for electronic device.

Said ionic cellulosic based material 1 is produced by positioning an ionic substance 11 into a cellulosic material 10 to form a web or a sheet, which may preferably be a continuous web or a sheet, of porous ionic cellulosic based material 1. It is to be understood that the positioning of the ionic substance 11 in some embodiments may preferably be into single pieces of a cellulosic material thereby forming pieces of porous ionic cellulosic based material 1, e.g. sheets of ionic paper or ionic board.

This type of porous ionic cellulosic based materials 1, e.g. ionic sheet or ionic paper, may be renewable since it comprises cellulosic fibers. The method of producing porous ionic cellulosic based materials 1, e.g. ionic paper, itself is easy and cost-effective wherein commercially available or laboratory made uncoated paper sheets may be used to deposit the ionic liquids on. The bulk paper itself become ionically conductive without significantly affecting the fiber-fiber bonding. There is only a slight difference of the whiteness value between the uncoated paper and the ionic paper (in the case where a white paper is used). Ionic conductivity has been proven to withstand at wide range of humidity starting from a 20% to 80% RH at 23° C.

In FIG. 2 a schematic view of a surface-sized ionic paper 1 is shown. A surface-sized layer 2 covers substantially the whole surface of both sides of the ionic paper 1. However, in some embodiments it may be more preferred to surface-size only one side of said web, sheet or piece of ionic cellulosic based material 1.

In FIG. 3 a schematic view of the ionic paper 1 having a surface-sized layer 2. Said surface-sized ionic paper is supplied with a conducting material 3 is shown. The conducting material 3 has been applied by printing conductive material 30 onto the surface-sized layer 2 of the ionic paper 1. The conducting material 30 may be deposited as lines or as dots or other suitable geometrical shapes. A distance between the depositions may preferably be required to ensure no immediate physical contact.

In FIG. 4 a schematic view of the surface-sized ionic paper is shown. Said surface-sized ionic paper is supplied with the conducting material 3 also on the other side of the sheet is shown. The underside has been supplied with a conducting material 3 which in the embodiment shown in FIG. 4 is supplied by coating a conductive material 31 on top of the surface-sized layer 2.

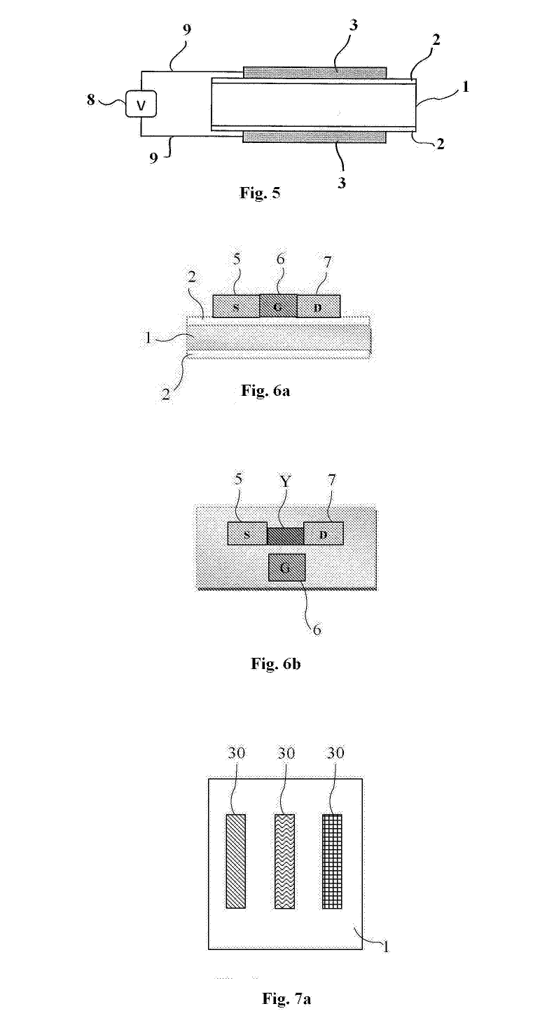

In FIG. 5 a schematic side view of the surface-sized ionic paper printed/coated with conducting material on both sides and an applied voltage between the conducting materials is shown. When voltage is applied to the conducting material 3 via electric wires 9 from voltage source 8 (minimum of 1.5 V) color changing occurs. The rate of color changing may depend on the ionic conductivity and on the voltage applied.

A side view of an electrochemical transistor 5, 6, 7 that can be built/printed on ionic paper is shown in FIG. 6a. The electrochemical transistor comprises a source 5, a gate 6 and a drain 7 which are placed on top of one side of the surface-sized ionic paper by means of a surface treatment method, such as a printing technique or a coating technique able to produce geometric patterns.

In FIG. 6b a top view of the electrochemical transistor as shown in FIG. 5a is shown. The gate 6 is placed at a distance from the source 5 and the drain 7. It is also possible to print the gate electrode on the opposite side of the ionic paper. The strip Y between the source 5 and the drain D may be a conducting polymer/electrochromic polymer, either similar to the one in the source S, drain D and gate G, or a different conducting/electrochromic polymer. The S and D could also be metallic substances.

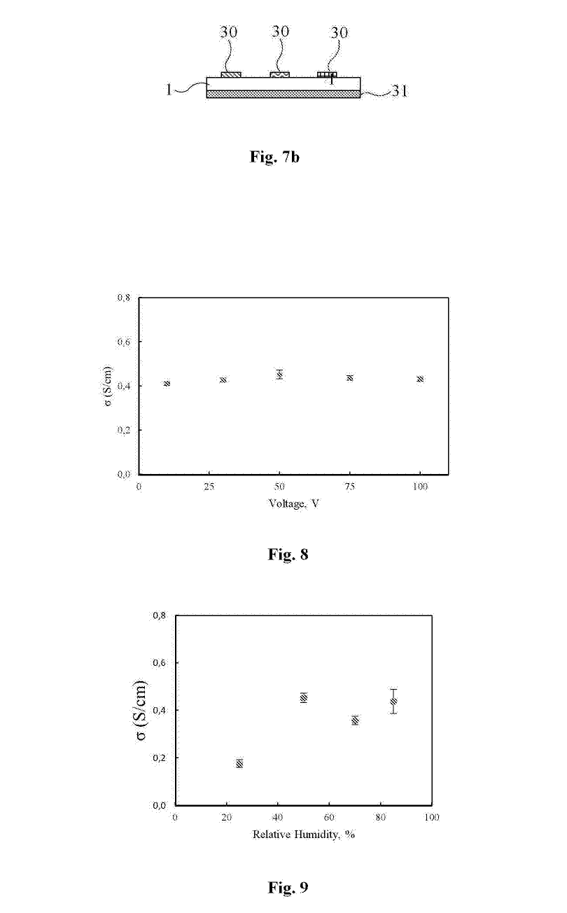

FIG. 7a shows that it possible to deposit, by means of a surface treatment method, such as a printing technique or a coating technique able to produce geometric patterns, fields or stripes of different electrochromic polymers 30 on top of the ionic paper 1 to render various colors when a voltage is applied.

FIG. 7b shows that a conducting polymer/electrohromic polymer 31 can be deposited, by means of a surface treatment method, such as a printing technique or a coating technique able to produce geometric patterns, on the other side of the ionic paper 1. The thickness of the ionic paper would be the separation distance between the electrochromic polymers on the top side and the conducting polymer on the other side. Investigations have been carried out to find a group of ionic liquids, henceforth also termed IL, that are inert to cellulosic materials, e.g. printing and graphic paper, packaging paper and board, corrugated board, non-wovens and textiles.

Ionic liquids (ILs) are generally salts in the liquid state based on a substituted heterocyclic cation and an organic or inorganic anion. One of the first ionic liquids synthesized was ethylammonium nitrate in 1914, although at that time it was called a fused salt. The term “ionic liquid” was first used in 1943. The melting point of ILs is below 100° C. The species of cation and anion and the length of the alkyl groups on the cation greatly influence their physical and thermal properties. Ionic liquids are made up of ions and short-lived ion pairs. Any salt that melts without decomposing or vaporizing usually yields an ionic liquid. Other terms for these substances include liquid electrolytes, ionic melts, ionic fluids, fused salts, and ionic glasses. Since the ionic bonds are stronger than the van der Waals forces between the molecules of an ordinary liquid, common salts tend to melt at a higher temperature than other solid molecules. There are ILs that are liquid at or below room temperature, and these are called room temperature ionic liquids (RTIL). ILs have very low vapor pressures which make them less harmful for respiratory organs as compared to other solvents. The properties such as melting temperature, thermal stability, refractive index, acid-base character, hydrophilicity, polarity density, and viscosity can easily be tailored. Imidazolium salts with C4-C6 moieties have high surface tension. In general, the surface tension of ionic liquids is higher than any solvents, except for water. The larger the anion of the ionic liquids the higher is the surface tension. Thermal stability of of ILs is very high (Tₒₙₛₑₜ 300 to 400° C. However, the thermal stability of the ionic liquid drops if the substance is exposed to longer period at elevated temperature. The viscosity of ILs are normally higher than that of water, and it decreases with increasing temperature. The viscosity is one of the important properties that affects the penetration of the of the IL into the fiber network.

Two of the room temperature ionic liquids that have been found not to dissolve cellulosic materials is 1-butyl-3-methylimidazolium tetrafluoroborate or [bmim]BF₄, and 1-butyl-3-methylimidazolium hexafluorophosphate or [bmim]PF₆.These ILs were also found to be a good electrolyte and solvent.

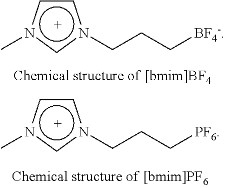

Ion conductivity is the ability of the material to transport electrical current via ions, or ions and electrons/holes. It relies on the mobility of these charge species, which has proven to be dependent on temperature and relative humidity.

In a preferred embodiment a porous ionic paper 1 is produced by depositing or applying a liquid 100 comprising an ionic substrate 11, which comprises an RTIL, e.g. [bmim]BF4, onto substantially the whole surface of a paper. The ionic substrate 11 penetrates to the interior of the paper though the pores of the paper and throughout the fiber network which then makes the surface of paper electrochemically active and not just the bulk. Said paper may be printing and graphic paper, packaging paper and board, and corrugated board.

The produced porous ionic paper, now deposited or applied with the ionic substrate 11 comprising e.g.[bmim]BF4, is allowed to dry, preferably followed by surface-sizing of substantially the whole of one or both of its sides. Any conventional surface-sizing agents may be used, preferably starch, starch-latex (SL) or nanofibrillated cellulose (NFC)-based sizing agents, and/or combinations thereof. The importance of sizing the ionic paper is for protection, better contrast of the substrate to electrochromic polymer while maintaining the electrochemical property of the ionic paper. After drying the ionic paper or the surface-sized ionic paper, the conducting material 3 in the form of an electrochromic polymer and/or an electrochemical field effect transistor is added to said surface-sized ionic paper or to said non-sized ionic paper.

Paper and board comprises a lot of ions from the papermaking process and one theory is that these ions may contribute to an inherent conducting capacity of the paper. These ions enhances the conductivity of ionic paper

### Study

The [bmim]BF4 was deposited onto a commercial base paper and the electrical behavior of the porous ionic paper produced was characterized under various conditions of relative humidity and temperature. Furthermore, the effect of surface sizing of the ionic paper on its electronic behavior was investigated and the electrochemical performance by screen-printing PEDOT:PSS ink onto the surface-sized ionic paper was demonstrated. PEDOT:PSS ink is an ink containing poly(3,4-ethylenedioxythiophene) doped with polystyrene sulfonate (PEDOT:PSS) and some additives, mainly to modify viscosity of the ink.

The ionic conductivity using four-probe technique at various voltages (FIG. 8) was measured. This technique is used to measure conductive sheets and minimize the effect of surface roughness. It was found that the ionic conductivity did not vary with the voltage applied between 10±1 and 100±1 V.

The subsequent measurements were made at 50±1 V. The electrical properties of paper are known to be greatly influenced by the moisture content in the atmosphere. The effect of relative humidity on the ionic conductivity of an ionic paper not surface-sized was determined, and it was observed that there seem to be a steep increase in ionic conductivity from approx. 25±5% RH to approx. 50±5% RH, whereas only a small difference was observed between 50±5 and 85±5% RH (FIG. 9). In this measurement, the temperature was maintained at 23±1° C. inside a climate chamber. This study was important to ensure that the ionic paper possesses a considerable ionic conductivity at both low RH (25%) or at high RH (85%), i.e. in tropical environment. Paper as such is sensitive to the moisture content in the atmosphere because of its hygroscopic properties.

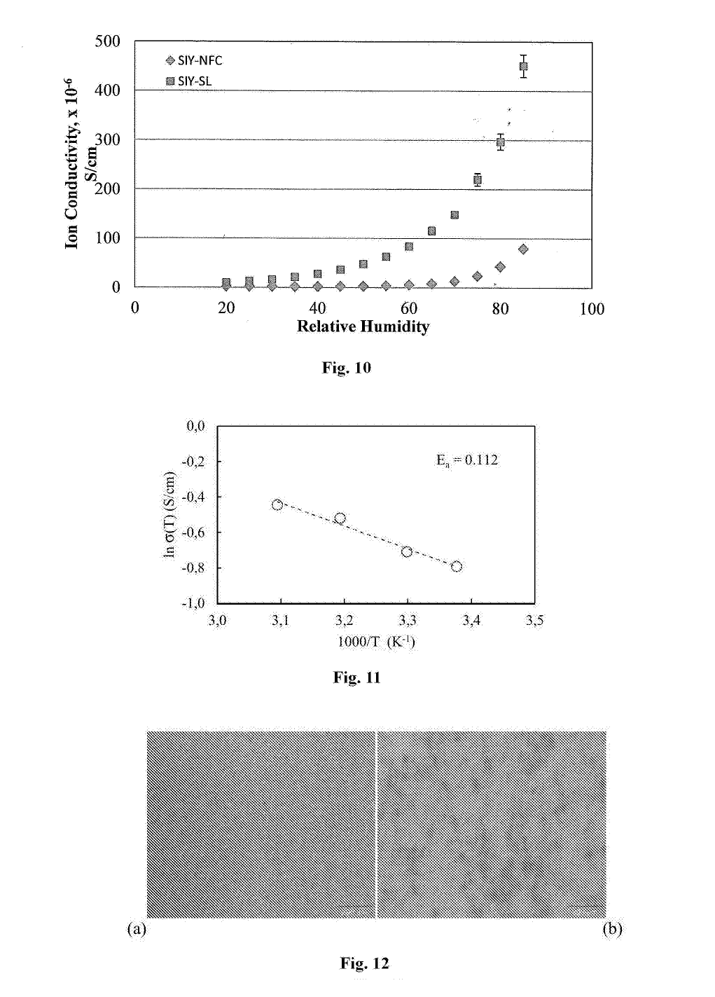

In FIG. 10 the effect of relative humidity on the ionic conductivity of an ionic paper having a surface-sizing layer comprising nanofibrillated cellulose (termed SIY-NFC), and an ionic paper having a surface-sizing layer comprising starch and latex (termed SIY-SL) is shown. It shows the behavior of ionic conductivity as a function of relative humidity. The ionic conductivity of SIY-NFC is highly dependent on humidity as compared to the SIY-SL. Comparing FIGS. 9 and 10, the surface-sized ionic paper is more dependent on humidity than the unsized ionic paper. The reason is simply that the structure of the sizing layer is dependent on the moisture content of the atmosphere. This is something that may have to be considered.

It was also observed that the ionic conductivity increased as the temperature increased. The temperature dependence of the ionic conductivity has been fitted to the William-Landel-Ferry (WLF) relationship and to a simple Arrhenius equation for the temperature range between 296 and 323 K. The mechanism of ionic conduction in a solid polymer electrolyte as expressed by the WLF relation is by a segmental motion of polymer chains in the amorphous region. The temperature behavior of the ionic conductivity did not fit the WLF equation. The Arrhenius equation is:

$$σ ( T ) = {σ}_{0} {e}^{- \frac{{E}_{a}}{kT}} \qquad ( 1 )$$

where σ(T) is the conductivity (S/cm), Ea is the activation energy, k is the Boltzman constant, and T is the temperature (K). The temperature dependence fitted the Arrhenius equation well. This behavior follows the hopping model of carrier ions which is typical the behavior of inorganic ion conductors. This indicates that the mechanism of ionic conduction is due to the inorganic anion BF4-. From the plot of ln σ(T) vs 1000/T (FIG. 11), the activation energy, Ea was calculated to be 0.112 eV. The activation energy is the minimum energy required to start the electrochemical process or charge transport.

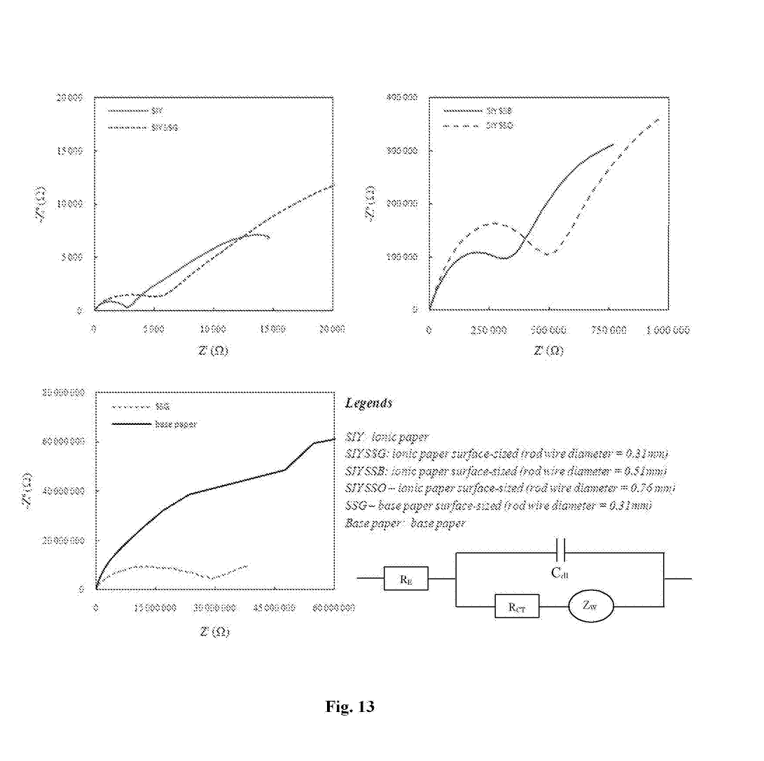

Surface sizing of an ionic paper affects the surface roughness and printability of the surface. This may be a beneficial step in order to create a smoother surface and thus, better printability of the electronic structure on top of the ionic paper. It may further be beneficial that the surface sizing is thin enough to allow fast diffusion of ions to and from the ionic paper. The presence of small openings in the form of pinholes or small uncovered areas on the surface may be an advantage provided that they do not compromise the surface smoothness and printability. In order to see whether this is accomplished, a standard test was performed to evaluate the presence of pinholes on the surface of the paper. A mixture of oil-soluble red dye, turpentine and anhydrous calcium carbonate was deposited on the face of the paper samples, and found that the mixture penetrated into the base and unsized paper as indicated by the wetting of the rear side of the paper. The surface-sized ionic papers, on the other hand, did not allow the complete penetration of the dye mixture. However, some concentrated red spots (shown as concentrated dark spots in FIG. 12) were observed on the rear side of the surface-sized paper which were attributed to uncovered areas on the front of the paper. These spots were due not only to pinholes at the front but also to larger uncovered areas. The presence of uncovered areas explains the color switching of printed electrochromic polymer when a voltage is applied. This phenomenon was not observed on printed electrochromic polymer on top of the surface-sized base paper. The sizing film itself seem to have a very low ionic conductivity.

Three different wire rods (green=0.31 mm, black=0.51 mm, orange=0.76 mm wire diameters) were used when surface sizing the ionic paper, to give surface sizing films with three different thicknesses. The surface roughness was evaluated using an optical profilometer and a difference was found in the surface topography of the different papers. The unsized samples have larger number of deep portions than the sized surfaces. This implies that many of the pores of the paper are covered by the surface sizing agent. The color of the fiber lines are more intense and more defined in the unsized than in the sized samples. However, the quantitative evaluation of the average roughness (Ra), and the root mean square roughness (Rq) for at least twelve samples did not give significant variation among the samples.

The Nyquist plots for the different paper samples show the effect of thickness of the surface sizing (FIG. 13). The general behavior of ionic paper, whether unsized or surface-sized, reveals a faradaic impedance as a serial combination of charge-transfer resistance and the Warburg impedance. The Warburg impedance indicates a purely diffusion-controlled reaction at the low-frequency limit. As the surface sizing increased, the bulk resistivity RB also increased. The values of the series resistance RE ranges from 116 to 124 Ω for ionic papers (unsized and sized). In FIG. 13 SIY is an ionic paper, i.e. an ionic paper according to the invention, SIYSSG is a surface-sized ionic paper where the surface-sizing rod wire diameter is 0.31 mm, SIYSSB is a surface-sized ionic paper where the surface-sizing rod wire diameter is 0.51 mm, SIYSSO is a surface-sized ionic paper where the surface-sizing rod wire diameter is 0.76 mm and SSG is a surface-sized base paper where the surface-sizing rod wire diameter is 0.31 mm. The term base paper means a paper not applied/treated with ionic liquids.

Color measurements (see Table 1 and 2) indicate that the polymer changes color to dark blue as indicated by increasing negative values of b*), and decreasing amount of L* as time progresses, when a voltage is applied. The color change is readily appreciable by the naked untrained eye. It is also evidenced by ΔE>4 to 4.5 (the value 4 to 4.5 is often referred to as a threshold when an ordinary observer can identify a change in color). The value of ΔE is calculated by the formula

ΔE={square root over ((L₂−L₁)²+(a₂−a₁)²+(b₂−b₁)²))}.

where the indices (1 and 2) denotes values of two different color coordinates given in, for instance, the L a b-system, which is used in the tables (tables 1 and 2) below. ΔE is the absolute value, of two different colors, or distance coordinates in color space in other terms. L a b data for 0 and 1 second in table 1, and L a b data for 0, 5, and 10 seconds in table 2 have been used in the estimations below.

The term SIY substrate means a substrate treated with ionic liquids, i.e. an ionic substrate.

In the case, tab. 1, of printing polymer on side (as depicted in FIG. 3) color change may be appreciable in one (1) second.

TABLE 1
L a b values as a function of time of the electrochromic polymer
PEDOT:PSS on SIY substrate when 9 V is applied (polymer is
printed on the same side of ionic paper with a separation
distance of about 2.5 mm).

| Time (s) | L* | a* | b* |
|---|---|---|---|
| 0 | 52 | −1 | −5 |
| 1 | 45 | −1 | −12 |
| 2 | 34 | 1 | −24 |
| 3 | 34 | 1 | −28 |
| 4 | 33 | 1 | −29 |
| 5 | 33 | 1 | −29 |
| 6 | 33 | 2 | −30 |
| 7 | 32 | 2 | −30 |
| 8 | 32 | 2 | −31 |
| 9 | 32 | 2 | −31 |
| 10 | 32 | 3 | −32 |

In table 2 results from color measurements of an ionic substrate surface-sized with a dispersion comprising nanofibrillated cellulose (termed SIY-NFC) are shown. The results indicate the color switching speed of this setup (illustrated in FIG. 5). In this case appreciable color change occurs after five to ten (5 to 10) seconds.

TABLE 2
L a b values as a function of time of the electrochromic polymer
PEDOT:PSS on SIY-NFC substrate when 9 V is applied (polymer
printed on both sides of the paper, the thickness of the paper plus
sizing layer layer is about 130 um).

| Time (s) | L* | a* | b* |
|---|---|---|---|
| 0 | 64 | −2 | −4 |
| 5 | 61 | −2 | −6 |
| 10 | 59 | −2 | −8 |
| 15 | 58 | −2 | −9 |
| 20 | 55 | −2 | −10 |
| 25 | 53 | −3 | −12 |
| 30 | 52 | −3 | −11 |
| 35 | 51 | −3 | −12 |
| 40 | 53 | −2 | −13 |
| 45 | 52 | −2 | −13 |
| 50 | 52 | −2 | −13 |
| 55 | 53 | −3 | −11 |
| 60 | 52 | −2 | −12 |

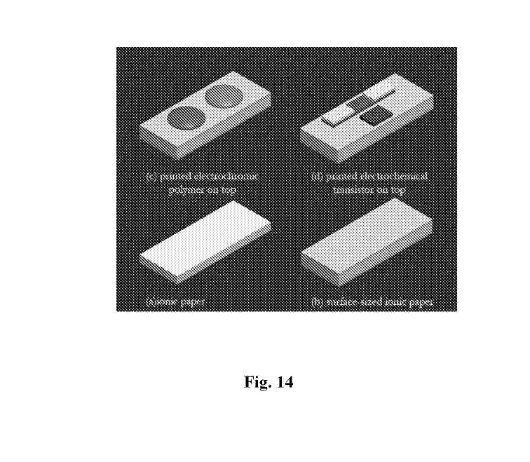

In order to evaluate the ionic properties of the ionic paper, an electrochromic polymer PEDOT:PSS was screen-printed on top of the surface of the surface-sized paper. The scheme (FIG. 14) shows that an electrochromic device (c) or an organic electrochemical field effect transistor (electrochemical FET) (d) may be printed onto the surface-sized ionic paper (b). Furthermore, in FIG. 12 an ionic paper (a) is shown. With the electrochromic device, the application of a voltage causes the printed PEDOT:PSS to switch color between transparent to blue depending on the redox state of the molecules. PEDOT:PSS is dark blue in its reduced state and transparent in its oxidized state.

It is possible to change the contrast of the printing by applying a voltage. It is possible to regulate the current that passes through the active polymer channel between the transistor drain and the source terminals by electrochemically doping or de-doping the PEDOT:PSS according to the reaction:

PEDOT⁺:PSS⁻+M⁺+e⁻⇄PEDOT⁰+M:PSS

The color change is reversible since, when the polarity of the voltage was reversed, the color changed back. In the case of electrochemical field effect transistor, when a positive voltage was applied to the gate with respect to the ground source, the printed gate turned dark blue from slightly transparent which indicated a change in the conductivity of the printed channel. That the electrochemical FET works on a surface-sized ionic paper was shown by the change in color to dark blue of the printed gate channel after application of a positive voltage between the gate and source ground, compared to the unchanged color of the gate printed on the base paper. There is a fast diffusion of ions to and from the conducting polymer due to some open structures present on the surface of the surface-sized ionic paper, as discussed earlier.

In this study, ionic paper was produced by depositing ionic liquid onto the commercial base paper. The conductivity of the ionic paper was insensitive to the voltage from 10 to 100 V. The ionic paper was exposed to various relative humidity levels and found that it had a high conductivity even at low relative humidity (25% RH). The temperature dependence of the ionic conductivity follows the simple Arrhenius equation, which can be attributed to the hopping of carrier ions. Surface sizing of the ionic paper decreased the roughness and improved its printability. The bulk resistance increased with increasing thickness of the surface sizing. It was also observed that there are open structures on the surface of the surface-sized paper which facilitate the electrochemical reaction of the PEDOT:PSS printed on the surface when the voltage is applied. It was demonstrated that the ionic paper is a good ionic conductor that can be used as component in a more compact electronic device.

### Experimental

### Materials

Commercial base papers (PM White, 100 g/m2) were provided by Billerud AB, Sweden. The analytical grade ionic liquid used in this study was 1-butyl-3-methylimidazolium tetrafluoroborate ([bmim]BF4) from Sigma-Aldrich Gmbh (Germany) (FIG. 1). The Orgacon transparent screen printing ink EL-P 3040 was purchased from Agfa (Belgium). This ink is a transparent conductive ink that contains PEDOT:PSS and a thermoplastic binder. The sizing agent used was a mixture of cationic starch (Cargill Nordic AB, Sweden) and basoplast® (BASF GmbH, Germany). The dye mixture used was composed of Sudan Red G (Sigma-Aldrich GmbH, Germany), analytical grade of anhydrous calcium chloride (Sigma-Aldrich, Germany), and balsam turpentine (Alcro Färg AB, Sweden). Additionally, a dispersion of nanofibrillated cellulose (NFC) may instead be used as a surface-sizing agent. A blend of NFC and poly(vinyl alcohol) PVA may also be used also as an alternative sizing agent. The thicknesses of the base and coated papers were measured using the STFI Thickness Tester M201 (Sweden).

### Deposition of Ionic Liquid

The commercial base paper was placed on top of a blotter and coated using an RK Control Coater (UK) with [bmim]BF4. The temperature of the ionic liquid was maintained at at least 23° C. A wire-wound rod with 0.08 mm wire diameter was used to ensure deeper deposition of the ionic liquid into the paper. The coated paper sample and the blotter were dried for 5 minutes using the STFI Infra-Red (IR) dryer (Sweden) at about 110° C. Dried samples were stored at 23° C. and 50% relative humidity (RH).

### Surface Sizing

A solution of 20 wt % cationic starch and 5 wt % basoplast was used as surface sizing agent. An amount of 66.5 g of the cationic starch (˜90.2% solid content) was poured into a flask containing the corresponding amount of water. The solution was boiled at 100° C. in a hot water bath with constant stirring. After 30 minutes, the solution was placed in an ice bath for rapid cooling down to 40° C. An amount of 15.0 g of basoplast was added to the starch solution and the resulting mixture was stirred for 1 hour. Alternatively, a dispersion of NFCor a blend of NFC-PVA may be used as surface-sizing agent. Surface sizing was performed using a bench coater (RK Coater) with rods wound with wires with different diameters. The surface-sized ionic paper was dried using the STFI- IR dryer for 90 s at 110° C. The dried surface-sized ionic papers were stored 23° C. and 50% RH.

### Electrical Characterizations

The four-probe technique was used to measure the conductivity of the coated paper samples according to ASTM D4496-04 inside the climate chamber (CTS Climate Test System AB, Sweden) where the relative humidity and temperature could be regulated. This standard measurement was used for moderately conductive sheets. The ionic paper samples were cut to 10×15 cm and placed in the measurement chamber. The two outer current electrodes were connected to one multimeter (Keithley 2000, USA) while the two inner potential electrodes were connected to another multimeter (Keithley 2000, USA). At least five samples were measured per treatment with similar conductivities. The impedance behavior of the base and ionic paper was measured using a Broadband Dielectric Spectrometer (Novocontrol Gmbh, Germany) inside the clean laboratory at a temperature of 21±1° C. and a relative humidity of 45±5%. Samples were cut into circles of diameter 2.5 cm and were sandwiched between two circular gold electrodes in a measurement cell. The set-up was tightened to ensure better contact of electrodes and the paper sample. A bias voltage of 1.0 VAC was applied and the frequency was swept from 100 mHz to 10 MHz. At least five measurements were made per sample.

### Optical Measurements

A mixture of dye consisting of 5.0 g of anhydrous calcium chloride, 1.0 g Sudan Red G, and 100 ml turpentine was prepared. The dye mixture was filtered through a filter paper. Paper samples were cut into 10 cm×10 cm, and the dye mixture was applied on the front of the paper using a paint brush. The painted paper samples were allowed to dry inside a fume hood for at least 15 minutes. Photomicrographs were taken using an Olympus System Microscope with Cell Imaging Software (Olympus GmbH, Germany) at 20× magnification. The surface topographic images were taken using the Wyko NT3300 Profiling System (Veeco, USA). The optical profilometer was set to: scan speed: 1×; resolution: full, FOV: 0.5, Objective: 5×, backscan: 30 μm, scanlength: 100 μm, modulation threshold: 1%, autoscan: enabled, percent modulated: 50%, post scan length: 30 μm, mode: VSI. For monitoring the change of colour when the voltage is applied, a digital pocket microscope (BYK DPM 100, Germany) was used.

### Screen Printing of Conducting Polymer

Screen-printing of the ionic paper/surface-sized ionic paper was performed using an A4 60-meshscreen print (Screentec AB, Sweden). The Orgacon EL-3040 screen printing ink was printed and the printed paper was dried in ambient condition.

### Demonstration of Electrochemical Property

The paper electrochromic device was placed in a laboratory electrode set up. The electrodes were positioned on the printed polymers, and a weight of about 2 kg was placed on top of the electrodes to ensure better contact with the printed structure. A change in color of the electrochromic polymer was immediately observed a voltage of about 5 VDC from a HP E 3631A power source (HP, USA) was applied. An image was captured after a few minutes later using a system camera (Nikon D3000, Japan).

This ionic paper may be used as platform for flexible electrochromic display materials such as in billboards, wall papers, in mobile displays, mobile readers, etc. It may also be used as sensor in detecting chemicals, light, and other stimuli. Another area of use is in photovoltaic, fuel cells, batteries, capacitors as solid electrolyte or ion conducting membrane.

The ionic deposition is mainly applied by deposition or application of said liquid (100) comprising room temperature ionic liquids in such a manner that the integrity and inherent properties (such as strength and converting performance) of the flexible web or sheet shaped material are not seriously compromised. The said invention also ensure a sustainable handling of resources minimizing use of chemicals and downstream effects in reclaiming of materials.

Exemplary applications

The present invention is suitable for a number of applications and can be used within a number of different technical fields. Two areas of specific interest are sensor and detection equipment for detecting physical properties of an object or a substance, and security and authentication equipment for guaranteeing the authenticity of an object or a seal for a packaging. These areas are also described in more detail below.

### Sensor Equipment

Thanks to the possibility of creating an electrochemical transistor on ionic paper as described above, a sensor assembly with said electrochemical transistor serving as a sensor can be manufactured. The number of sensors or transistors can vary depending on the particular application and can be as many as can conveniently be applied to a given piece of ionic paper through a suitable method, for instance through printing.

A power supply for supplying electrical power is connected to each of said transistors, and a read out or output device is also connected to receive data from said transistors. If suitable, said power supply and read out device can be an integrated unit, such as a mobile telephone or portable computer, and it can also comprise a data processing unit and memory unit for processing and/or storing data received from said transistor or transistors, as well as a graphic interface and an electronic control capacity. A power supply of up to 9 V is suitable for most applications of this type.

By thus using the ionic paper with at least one transistor as a sensor unit, a physical or electrical property of an object or a substance, as well as the presence of a particular substance, can be detected. The electrochemical response of the transistor can be altered by attaching reagents to a site, preferably the source or drain so that a specific reaction to a sought after agent is produced and the presence of this agent is thereby detected. Such reagents could be enzymes and/or other suitable chemicals. It may also be possible to use antibodies conjugated with appropriate enzymes as reagents. Certain ions may be used as indicators for sensors signals, e.g. metal ions, phosphate ions, nitrate ions and sulphate ions. These ions may function as doping agents for the transistors and could thereby influence/enhance the response such as making the response detectable. Within the field of medicine, for instance, the sensor assembly could be used to detect sugars and proteins in bodily fluids, and within the field of horticulture or agriculture, chemicals, chemical conditions and specific proteins and enzymes can be detected in soil. In a food stuff application, the sensor assembly can be used to detect chemicals, chemical conditions and specific proteins and enzymes in a foodstuff, on a surface of a foodstuff or in its surroundings.

Alternatively, the reagent or reagents can be applied to the ionic paper itself rather than a site of a transistor on said ionic paper.

After detecting a property as described above, data are transmitted from said transistor or transistors to the read out device and can be displayed to a user through a graphic interface or in another suitable manner. The data can be stored for later retrieval and can be processed in different ways to yield new data, if desired by the user. Also, output data from the transistor or transistors can be combined with other data such as information regarding a time or place of measurement, as well as other data relating to the sensing or detection of a substance or object.

### Security and Authentication Equipment

A flexible electronic device such as a transistor mounted on an ionic paper can form an authentication device thanks to the ability for color change described in detail above, for instance with reference to FIG. 5. Thus, in a first chemical state the authentication device can have a first color, and when an electrical current flows through the flexible electronic device said first chemical state can be changed to a second chemical state where the device displays a second color. The flexible electronic device can for instance be a transistor printed on the paper.

In order to use the authentication device, the paper on which it is printed can be connected to a power source to form an electrical circuit in such a way that a current flows through the circuit and through the flexible electrical device, thus altering the color from the first color to the second and altering the first chemical state to the second chemical state accordingly. The flexible electronic device can be mounted on one side or both sides of said ionic paper, depending on the specific application.

Thus, if the expected color change occurs, a person testing the authenticity of a piece of paper can be assured that it is in fact genuine. One application for this technology would be valuable papers such as banknotes. Thanks to the connection to an external power supply, the authenticity can be tested multiple times and between the tests no electrical energy is consumed by the authentication device, rendering the maintenance costs very low.

In another embodiment, the power supply can be integrated with the ionic paper to form a circuit where the flexible electronic device before testing is in the second chemical state displaying the second color. By breaking the circuit, the device will be placed in the first chemical state displaying the first color, showing clearly that no current flows through the flexible electronic device. After the circuit is broken, it can be very difficult to reconnect it and thereby display the second color again. Suitable applications for this technology are sealing objects for a packaging or objects used only one time, such as lottery tickets or other tickets. Thus, to verify the authenticity of the object, a person performing the verification need only break or tear the object such that the circuit is broken, and observe that an irreversible color change does indeed take place. If placed on a sealing object such as a sticker for a crate or box, the receiver can immediately see that the seal has not been tampered with during transportation or the like simply by observing the color of the authentication device.

The invention also concerns a method for verifying an authenticity of an object, featuring the steps of providing an authentication device comprising an ionic paper and a flexible electronic device mounted on said ionic paper, wherein said flexible electronic device is in a first chemical state associated with a first color, and connecting a power supply to said flexible electronic device so that said flexible electronic device changes to a second chemical state associated with a second color.

As will be understood by those skilled in the present field of art, numerous changes and modifications may be made to the above described and other embodiments of the present invention, without departing from its scope as defined in the appending claims. For instance, different types of transistors can be created by the methods of the invention described above, such as bipolar transistors or field effect transistors, for instance.

For example, the deposition of ionic liquids may be done on non-sized cellulosic materials, e.g. paper and board, as well and still achieve the benefits of the invention.

It is further understood that the method of producing porous ionic conducting material comprising the step of positioning an ionic substance into cellulosic material may be done to form three-dimensional ionic conducting cellulosic based articles and objects as well and not only to form a continuous web or individual sheets of porous ionic cellulosic based material.

It should be noted that the above described aspects may be the subject for its own protection, as such in a separate divisional application.

1-18. (canceled)

19. An authentication device for verifying the authenticity of an object, comprising at least one flexible electronic device according to any of the claims 8-10, said flexible electronic device having a first chemical state associated with a first color, characterized by said flexible electronic device being connectable to a power supply to form an electrical circuit in such a way that an electrical current can flow through said flexible electronic device, and said flexible electronic device being arranged to be in a second chemical state associated with a second color when a current flows through said flexible electronic device.

20. An authentication device according to claim 19, characterized in said power supply being connected to said flexible electronic device to form an integrated circuit.

21. A method for verifying an authenticity of an object, featuring the steps of:
(a) providing an authentication device comprising an ionic paper and a flexible electronic device mounted on said ionic paper, wherein said flexible electronic device is in a first chemical state associated with a first color, and
(b) connecting a power supply to said flexible electronic device so that said flexible electronic device changes to a second chemical state associated with a second color.

22. A method of producing porous ionic conducting material, comprising the step of:
positioning an ionic substance into cellulosic material to form a continuous web or at least one individual sheet of porous ionic cellulosic based material, wherein the steps of first producing a web or sheet shaped cellulosic based substrate and thereafter applying a liquid comprising room temperature ionic liquids.

23. The method according to claim 22, wherein said liquid is applied by means of a surface treatment method able to transfer the room temperature ionic liquids to the cellulosic material.

24. The method according to claim 23, wherein said application includes a step of applying pressure arranged to ensure the positioning of the ionic liquid into the cellulosic material, preferably in the form of said surface treatment method, which preferably is a printing technique or a coating technique able to transfer the room temperature ionic liquids to the cellulosic material.

25. The method according to claim 22, further comprising applying a sizing layer onto at least one side of said web or sheet.

26. The method according to claim 25, further comprising applying both sides with a sizing layer.

27. The method according to claim 25, further comprising applying a surface-sizing agent comprising starch, latex and/or nano-fibrillated cellulose and/or polyvinyl alcohol.

28. The method according to claim 25, further comprising applying said sizing layer having a thickness in the range of 1 -120 μm, preferably in the range of 5-60 μm, and more preferred 20-40 μm.

29. The method for producing a flexible electronic device, characterized by using a substrate in accordance with claim 22 and applying a conducting material.

30. The method according to claim 29, wherein said conducting material is supplied to form at least one electronic device.

31. The method according to claim 30, wherein said electronic device comprises at least one electro chemical transistor.

32. A flexible web or sheet shaped material comprising an ionic substance, characterized by being mainly formed by a cellulosic fiber web or sheet comprising ionic substances applied by means of a liquid and by said ionic substance being mainly applied by deposition or application of said liquid comprising room temperature ionic liquids.

33. The flexible web or sheet shaped material according to claim 32, wherein said web or sheet shaped material comprises at least 90% renewable material, preferably biodegradable renewable material.

34. The flexible web or sheet shaped material according to claim 32, wherein at least one of the sides of said web or sheet is arranged with a sizing layer.

35. A sensor assembly for sensing a property of an object, comprising at least one sensor, a power supply connected to said sensor and a read out device connected to said sensor, wherein said sensor assembly comprises a flexible web or sheet shaped material according to claim 32.

36. The sensor assembly according to claim 35, wherein said sensor comprises at least one transistor mounted on said flexible web or sheet shaped material.

37. The sensor assembly according to claim 36, wherein at least one site of said transistor comprises a reagent.

38. The sensor assembly according to claim 37, wherein said flexible web or sheet shaped material comprises a reagent.

39. The sensor assembly according to claim 35, wherein said read out device comprising at least one of a graphic interface, a data processing capacity, and an electronic control capacity.
